(19) United States
(12) Patent Application Publication
(10) Pub. No.: US 2008/0309179 A1
(43) Pub. Date: Dec. 18, 2008

(54) Electric Machine

(75) Inventors: Werner Eberlein, Erlangen (DE); Valery Lazouski, Minsk (BY); Klaus Recker, Neumarkt (DE); Siarhei Sidaruk, Minsk (BY); Vladimir Zharski, Minsk (BY)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 11/663,244

(22) PCT Filed: Sep. 16, 2005
(86) PCT No.: PCT/EP05/54602

§ 371 Date: Aug. 5, 2008

(30) Foreign Application Priority Data
Sep. 20, 2004 (DE) 10 2004 045 493.0

(51) Int. Cl. H02K 7/06

(52) U.S. Cl. 310/80

(57) ABSTRACT

There is described an electric machine which is used, in particular as a drive mechanism for an injection moulding machine. The electric machine comprises a first electric motor for carrying out a linear displacement and a second electric motor for carrying out a rotational movement. A displaceable means can be displaced in a rotary and linear manner by means of the rotational displacement and the linear displacement. A first axle of the first electric motor essentially coincides with a second axle of the second electric motor and the linear displacement can be carried out by means of a threaded drive. A second rotor of the second electric motor is connected to a drive means of the threaded drive. It is also possible that the first electric motor is positioned in such a manner in relation to the second electric motor that a region is formed in the same axial position. As a result, a compact machine is produced.

### CROSS REFERENCE TO RELATED APPLICATIONS

This application is the US National Stage of International Application No. PCT/EP2005/054602, filed Sep. 16, 2005 and claims the benefit thereof. The International Application claims the benefits of German application No. 10 2004 045 493.0 DE filed Sep. 20, 2004, both of the applications are incorporated by reference herein in their entirety.

### FIELD OF INVENTION

The invention relates to an electric machine, which is provided in particular as a drive for an injection molding machine. The electric machine is designed such that it is capable of implementing both an excursion movement and a rotary movement. For this purpose, the electric machine has at least two electric motors. The electric motors are arranged coaxially with respect to one another.

### BACKGROUND OF INVENTION

Such an electric machine is known, for example, from DE 43 44 335 A1. It is used, for example, in an injection molding machine, such an injection molding machine being known, for example, from EP 0 204 002 B1.

Various demands can be placed on an electric machine. One demand is, for example, a compact design, which is also of particular significance in the case of injection molding machines, since these also always have a compact design. Another demand placed on electric machines is, for example, a simple design. This makes it possible to reduce manufacturing costs, for example.

### SUMMARY OF INVENTION

An object of the invention is to develop an electric machine such that a compact and/or simple design of this electric machine is possible.

In accordance with the invention, this object is achieved by an apparatus as claimed in the independent claims. Dependent claims show further configurations of the the invention.

The electric machine according to the invention, which is provided in particular as a drive for an injection molding machine (for example for plastic), is designed to implement a rotary movement and to implement a linear movement. A first electric motor is provided for implementing the linear movement, and a second electric motor is provided for implementing the rotary movement. By means of the two electric motors, a moveable means can be moved both in rotary and linear fashion. The moveable means is, for example, a shaft. The electric motors have axes. The first electric motor has a first axis, and the second electric motor has a second axis. The first and the second axes essentially correspond to one another. This means that the electric motors are arranged coaxially. The linear movement can be carried out by means of a threaded mechanism. The threaded mechanism is, for example, a threaded spindle on which a threaded nut is arranged. The threaded nut is capable of moving linearly by means of a rotation of the threaded spindle. The electric machine according to the invention is characterized by the fact that a first rotor of the first electric motor is connected directly to the threaded mechanism, and a second rotor of the second electric motor is connected to a threaded mechanism means of the threaded mechanism. The threaded mechanism means is, for example when using a threaded spindle, a threaded nut.

In addition to a first rotor, the first electric motor also has a first stator. In addition to a second rotor, the second electric motor also has a second stator. The designation of first and second stator or first and second rotor is intended in this context to serve the purpose of differentiating between the rotor or the stator of the first and the second motor. The difference between a first rotor and a second rotor is therefore used for the assignment of the rotor either to the first electric motor or to the second electric motor. The same applies to the stator.

By means of the direct connection between the first rotor and the threaded mechanism, it is possible to realize a simple design of the electric machine. For example, it is not necessary to design the threaded mechanism with a drilled hole for the purpose of inserting a shaft for rotary movements.

In one advantageous configuration, at least one of the electric motors is a hollow shaft electric motor. The use of a hollow shaft electric motor makes it possible to achieve a more compact design of the electric machine. The two motors can therefore be interconnected.

In a further advantageous configuration, the first electric motor and the second electric motor have a region having the same axial position. The first electric motor and the second electric motor are therefore arranged such that they overlap one another entirely or at least partially. However, an onion like positioning of the electric motors in relation to one another results. This has the advantage that, as a result, a particularly compact design can be achieved. In particular, the axial length of the electric machine can be substantially shortened thereby.

The abovementioned object is further achieved by means of an electric machine, which is provided in particular as a drive for an injection molding machine, the electric machine having a first electric motor for the purpose of implementing a linear movement and a second electric motor for the purpose of implementing a rotary movement, a moveable means being capable of moving in rotary and linear fashion by means of the rotary movement and the linear movement, a first axis of the first electric motor essentially corresponding to a second axis of the second electric motor, and it being possible for the linear movement to be carried out by means of a threaded mechanism. It is characteristic of such an electric machine that the first electric motor and the second electric motor have a region having the same axial position. This means that the first electric motor has, entirely or at least partially, the same axial position as the second electric motor.

In a further advantageous configuration of the electric machines according to the invention, the stator of the first electric motor, which is also referred to as the first stator, can be cooled by means of a cooling device. The second stator of the second electric motor can also be cooled by means of a cooling device. Advantageously, the first stator and the second stator have a common cooling device, the common cooling device being arranged in particular between the first stator and the second stator. The common cooling device is, for example, helical, for example cooling coils, which can have cooling air or a cooling liquid applied to them, extending on a cylindrical outer side of the first stator and at the same time extending on an inner cylindrical side of the second stator, the second electric stator being, for example, the stator of an external rotor motor. The use of a cooling device for cooling two electric motors makes it possible to achieve improved compactness of the electric machine.

In a further advantageous configuration, the second electric motor is connected to the threaded mechanism means by means of a linear bearing. In this way, the threaded mechanism means is capable of moving both in linear and rotary fashion.

It is furthermore advantageous if the linear bearing has at least three linear guides, which are arranged in angle symmetrical fashion. Each of the linear guides has, for example, a rail and a carriage, the carriage having a ball chain (or a circulating ball chain). Linear bearings can also be designed such that they have a sliding bearing, a rolling bearing or else a ball bearing.

Advantageously, the first rotor is mounted by means of an axial bearing and by means of a radial bearing. In one further configuration, both bearings can also be replaced by a single bearing, this bearing having to absorb both radial forces and axial forces. A bearing is referred to as an axial bearing and/or a radial bearing depending on the loading direction envisaged for this bearing.

The electric machine can furthermore be designed such that the second rotor is mounted by means of a radial bearing.

The bearing of the first rotor and the bearing of the second rotor advantageously have a fixed connection to a common element. The common element is, for example, a housing part of the electric machine.

In a further configuration of the invention, the threaded mechanism is a threaded spindle, the threaded mechanism means being a threaded nut, the threaded spindle in particular being in the form of a ball-screw spindle.

In order to be able to regulate the electric machine, both the first electric motor and the second electric motor have at least one position sensor. The position sensors are used for regulating the position of the two electric motors, the position sensors in particular being positioned between the stator and the rotor.

In order to regulate the electric machine, a regulating system is provided. The regulating system is designed such that the first electric motor is regulated in terms of an angular difference between a required rotary angle of a drive shaft and/or in terms of an excursion, it being possible for the excursion to be calculated by means of the spindle gradient and the rotary angle. The second electric motor can be regulated by means of the regulating system, for example in terms of the rotary angle of the drive shaft.

The regulation of the rotary angle is to be understood, for example, as meaning a speed regulation and/or a position regulation of a rotary movement.

The invention further relates to an injection device for an injection molding machine, which has an advancing screw and the electric machine, in one of the above-described configurations, is provided for driving the advancing screw.

### BRIEF DESCRIPTION OF THE DRAWINGS

An exemplary embodiment of the invention is illustrated in the drawing and will be explained in more detail below. In the drawing:

FIG. 1 shows the basic design of the electric machine according to the invention,

FIG. 2 shows the basic design of an injection molding machine, and

FIG. 3 shows the illustration of an electric machine.

### DETAILED DESCRIPTION OF INVENTION

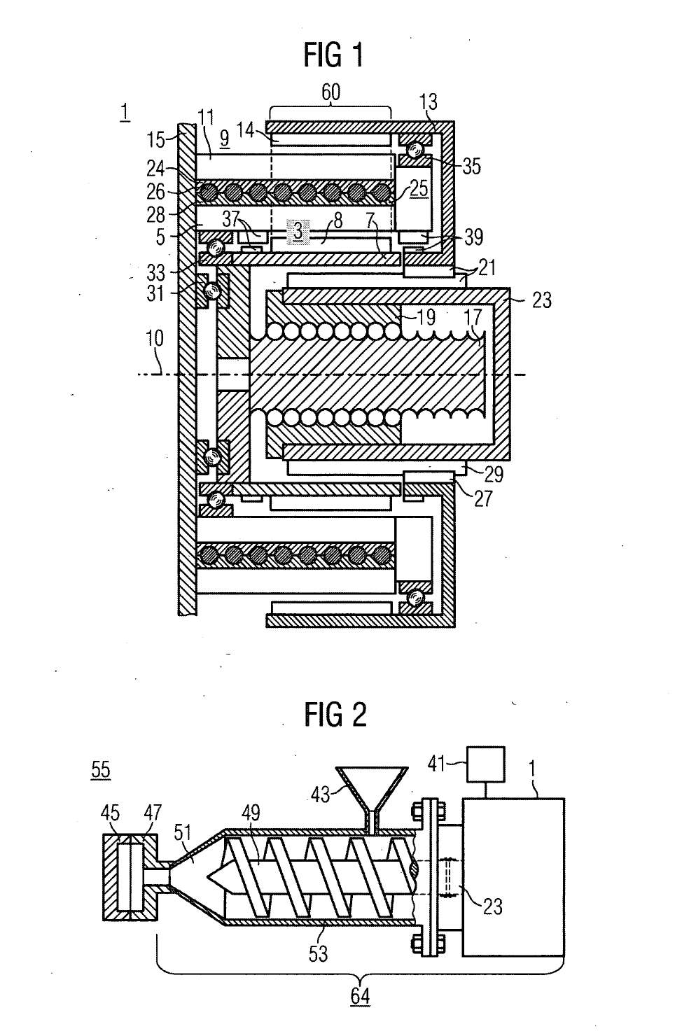

The illustration in FIG. 1 shows an electric machine 1. The electric machine 1 has a first electric motor 3 and a second electric motor 9. The first electric motor 3 has a first stator 5 and a first rotor 7. The first rotor 7 has permanent magnets 8. The second electric motor 9 has a second stator 11 and a second rotor 13. The second rotor 13 has permanent magnets 14.

By means of the electric machine 1, rotary and also linear movements can be carried out. In order to carry out linear movements, a threaded spindle 17 is provided. A threaded nut 19 rests on the threaded spindle 17. Mounting takes place, for example, via balls such that a threaded roller spindle is provided. The balls are not illustrated in FIG. 1, however. By means of the electric machine, both a linear movement and a rotary movement can be produced, with the result that the electric machine represents an excursion and rotary drive. The first electric motor 3 and the second electric motor 9 are hollow shaft electric motors. The electric motors 3, 9 are arranged coaxially with respect to a drive shaft 23. The drive shaft in particular an axis of the drive shaft can also be positioned such that it is aligned with the axes 10 of the electric motors 3, 9. Given an aligned arrangement of parts, there are parts which do not overlap but form an alignment in terms of their positioning with respect to one another. Parts which are arranged such that they are aligned are arranged one behind the other.

In order to realize a compact design of the electric machine 1, the electric motors 3, 9 are arranged such that they are interconnected. The stator 5 of the first electric motor 3 and the stator 11 of the second electric motor 9 are fixed to a machine housing 15. The rotor 7 of the first electric motor 3 and the rotor 13 of the second electric motor 9 are mounted on the machine housing 15, the mounting also taking place, for example, by means of an element fitted to the machine housing 15, such as a stator 5, 11, for example. The rotor 7 of the first electric motor and the rotor 13 of the second electric motor 9 are connected to a ball-screw mechanism. The ball-screw mechanism has at least the threaded spindle 17 and the threaded nut 19. The rotor 7 of the first electric motor 3 is fixedly connected to the threaded spindle 17. The rotor 13 of the second electric motor 9 is connected to the threaded nut 19 of the ball-screw mechanism via a linear bearing 21. The linear bearing 21 has, for example, linear guides having a ball chain. The threaded nut 19 is fixedly connected to the drive shaft 23.

The illustration in FIG. 1 further shows a carriage 27 and a running rail 29 of the linear bearing 21. The linear bearing 21 is connected to a drive shaft 23. The drive shaft 23 is in the form of a hollow tube. The cavity in the hollow tube results in a cut away portion in the form of an annular cavity for the entry of the threaded spindle 17. The carriages 27 of the linear bearing 21, which is in the form of a linear guide, are fixed to the rotor 13 of the second electric motor 9 via the running rails 29 of the linear guide to the drive shaft 23. The linear guide has, for example, three carriages 27 or three running rails 29. Owing to the number of three running rails 29, it is possible to provide for the linear movement of the drive shaft 23 in a simple manner.

The rotor 7 of the first electric motor 3 is mounted on the machine housing 15 by means of an axial bearing 31 and a radial bearing 33. The rotor 13 of the second electric motor 9 is mounted on the machine housing 15 by means of a radial bearing 35.

As shown in FIG. 1, the positioning of the first electric motor 3 in relation to the second electric motor 9 forms a region 60 having the same axial position. The axes 10 of the two electric motors coincide in this case. The region 60 having the same axial position relates in particular to a region in which the first rotor 7 has at least partially the same axial position as the second rotor 13. The first electric motor 3 has the same axis 10 as the second electric motor 9.

A cooling device 25 is positioned between the stator 5 and the stator 11. The cooling device 25 has a shaped part 24 and a shaped part 28, the cooling channels 26 being formed by means of the shaped parts. The cooling channels 26 are provided, for example, for guiding a cooling air flow or a cooling liquid.

Both the first electric motor 3 and the second electric motor 9 can be implemented, for example, as permanently excited three phase synchronous motors with windings in the stators 5 and 11. The rotors 7 and 13 have permanent magnets 8. The three phase synchronous motors 3, 9 are characterized by a high torque density. Owing to the use of a hollow shaft, a compact design of the electric machine can be ensured.

In order to regulate the electric machine 1, position sensors are provided for the electric motors 3, 5. A position sensor 37 is provided for determining the position of the first electric motor 3, and a position sensor 39 is provided for determining the position of the second electric motor 9. The electric motors 3, 9 can be regulated in terms of their position and speed by means of the position sensors. The first electric motor 3 is regulated, for example, in terms of an angular difference φ1 between the required rotary angle φ of the drive shaft 11 and the required excursion X converted from the spindle gradient h in relation to the rotary angle.

The second motor 2 is regulated in terms of the required rotary angle φ of the drive shaft 11.

The desired angle values φ1 for the first motor 1 and φ2 for the second motor 2 are calculated as follows:

φ1=φ360*Xh

φ2=φ
where:
   φ=desired angle value for the drive shaft in degrees
   X=desired excursion value for the drive shaft in meters
   φ1=desired angle value for the first motor in degrees
   φ2=desired angle value for the second motor in degrees
   h=spindle gradient for ball-screw mechanism in meters.

The torques M1 for the first motor 1 and M2 for the second motor 2 are calculated as follows:

M1=F*h/(2π)

M2=M M1
where:
   F=desired force value at the drive shaft in N
   M=desired torque value at the drive shaft in Nm
   M1=torque for the first motor in Nm
   M2=torque for the second motor in Nm
   H=spindle gradient for ball-screw mechanism in meters.

As a result of the fixed connection between the drive shaft and the threaded nut, and not the threaded spindle, as is the case in the known solution, the threaded spindle is simplified since it no longer requires any internal linear bearing and can be designed with a standard spindle. As a result of the two motors being installed inside one another, and not next to one another, a very compact design is achieved, it thus being possible to reduce the total length of the drive. Thanks to the embodiment of the first motor 3 as an internal rotor motor and of the second motor 9 as an external rotor motor and thanks to the installation of a water cooler 25 between the stators 5, 11 of the two motors, installation space for water coolers 25 is also saved, since one cooler cools both motors 3, 9.

The illustration in FIG. 2 shows, schematically, a plastic injection molding machine 1, which has an injection device 64. An advancing screw 49 is arranged within a screw housing 53. The advancing screw 49 is coupled, for example, to the drive shaft 23. The drive shaft 23 can be driven by means of the electric machine 1. The regulation of the electric machine takes place by means of the regulating system 41. In the plastic injection molding machine 55, plastics granules, which are not illustrated for reasons of clarity, are filled into a funnel 41 and pass via an opening into the screw housing 53. The advancing screw 49, which is helical, is driven by the electric machine 1 and conveys the plastics granules into the advancing screw space 51. Heating sections are generally located in the axial direction along the screw housing 53 and contribute to the plastics granules being present in plastified form in the advancing screw space 51. The heating sections are not illustrated in the simplified illustration of the plastic injection molding machine 55 in FIG. 2. The plastified and free flowing plastics material is introduced into a plastic injection molding die from a nozzle shaped opening in the screw housing 53. The plastic injection molding die has, for example, two die parts 45 and 47. The free flowing, plastified plastic material solidifies in the plastic injection molding die and, after the injection process, can be released from the die by the die parts 45 and 47 being moved apart from one another.

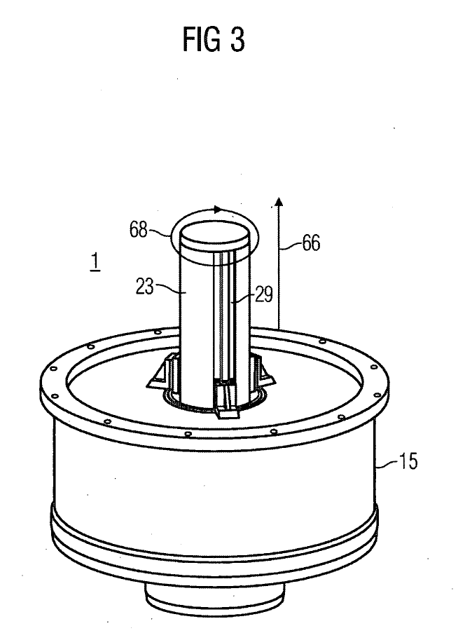

The illustration in FIG. 3 shows an electric machine 1 in a perspective illustration, the corresponding reference symbols in FIGS. 1 and 2 being used. The illustration shows the drive shaft 23 and a running rail 29. In addition, the possible movement directions 66 and 68 are shown in a rotor direction 68 and a linear direction 66. The machine housing 15 in this case can be regarded as being stationary.

1.-10. (canceled)

11. An electric machine, comprising:
a first electric motor for implementing a linear movement having a first rotor and a first axis, wherein the linear movement is carried out by a threaded mechanism having a first part and a second part movable against each user;
a second electric motor for implementing a rotary movement having a second rotor and a second axis, wherein the first axis essentially corresponds to the second axis; and
a moveable device that moves in rotary fashion based upon the second electric motor and further moves in linear fashion based upon the first electric motor, wherein the first rotor is connected to the first part of the threaded mechanism and the second rotor is connected to the second part of the threaded mechanism.

12. The electric machine as claimed in claim 11, wherein the first part of the threaded mechanism is a threaded spindle.

13. The electric machine as claimed in claim 12, wherein the second part of the threaded mechanism is a threaded nut.

14. The electric machine as claimed in claim 11, wherein the first electric motor and the second electric motor have at least partially the same axial position.

15. The electric machine as claimed in claim 11, wherein the electrical machine is a drive for an injection molding machine.

16. The electric machine as claimed in claim 11, wherein the first electrical motor has a first stator and the second electrical motor has a second stator, wherein the first stator and the second stator have a common cooling device, wherein the common cooling device is arranged between the first stator and the second stator.

17. The electric machine as claimed in claim 11, wherein the second electric motor is connected to the threaded mechanism via a linear bearing.

18. The electric machine as claimed in claim 11, wherein the first rotor is mounted via an axial bearing and via of a radial bearing.

19. The electric machine as claimed in claim 11, wherein the second rotor is mounted via a radial bearing.

20. The electric machine as claimed in claim 12, wherein the threaded spindle is a ball-screw spindle.

21. The electric machine as claimed in one of claims 11, wherein the first electric motor is controlled via a regulating system based upon an excursion, wherein the excursion is calculated based upon a spindle gradient and an rotary angle of the threaded mechanism and the second electric motor is controlled via the regulating system based upon a rotary angle of a drive shaft of the electric machine.

22. An electric machine, comprising:
a first electric motor for implementing a linear movement having a first rotor and a first axis, wherein the linear movement is carried out based upon a threaded mechanism;
a second electric motor for implementing a rotary movement having a second rotor and a second axis, wherein the first axis essentially corresponds to the second axis, wherein the first electric motor and the second electric motor have an area of the same axial position; and
a moveable device that moves in rotary fashion based upon the second electric motor and further moves in linear fashion based upon the first electric motor.

23. The electric machine as claimed in claim 22, wherein the electrical machine is a drive for an injection molding machine.

24. The electric machine as claimed in claim 22, wherein the first electrical motor has a first stator and the second electrical motor has a second stator, wherein the first stator and the second stator have a common cooling device, wherein the common cooling device is arranged between the first stator and the second stator.

25. The electric machine as claimed in claim 22, wherein the second electric motor is connected to the threaded mechanism via a linear bearing.

26. The electric machine as claimed in claim 22, wherein the first rotor is mounted via an axial bearing and via of a radial bearing.

27. The electric machine as claimed in claim 22, wherein the second rotor is mounted via a radial bearing.

28. An injection device for an injection molding machine, comprising:
an electric machine, wherein the electric machine comprises:
a first electric motor for implementing a linear movement having a first rotor and a first axis, wherein the linear movement is carried out based upon a threaded mechanism;
a second electric motor for implementing a rotary movement having a second rotor and a second axis, wherein the first axis essentially corresponds to the second axis, wherein the first electric motor and the second electric motor have an area of the same axial position; and
a moveable device being capable of moving in rotary fashion based upon the second electric motor and being capable of moving in linear fashion based upon the first electric motor; and
an advancing screw, wherein the the advancing screw is driven via the electric machine.
